(19) United States
(12) Patent Application Publication
(10) Pub. No.: US 2004/0083570 A1
(43) Pub. Date: May 6, 2004

(54) Robot cleaner, robot cleaning system and method for controlling the same

(76) Inventors: Jeong-Gon Song, Gwangju-City (KR); Ju-Sang Lee, Gwangju-City (KR); Jang-Youn Ko, Gwangju-City (KR)

Correspondence Address: LADAS & PARRY, 224 SOUTH MICHIGAN AVENUE, SUITE 1200, CHICAGO, IL, 60604, US

(21) Appl. No.: 10/406,375

(22) Filed: Apr. 3, 2003

(30) Foreign Application Priority Data
Oct. 31, 2002 (KR) 2002-66743

(51) Int. Cl. A47L 5/00

(52) U.S. Cl. 15/319; 15/340.1

(57) ABSTRACT

A robot cleaner, a robot cleaning system and a method for controlling the same that is capable of independently determining whether a cleaning work in a work area is completed. This is accomplished by providing a robot cleaner for performing cleaning work by communicating wirelessly with an apparatus external to the robot cleaner, comprising a main body provided with a suction unit for collecting dust on a floor to be cleaned, a driving unit disposed on the main body for driving a plurality of wheels, an upward-looking camera disposed on a top of the main body for photographing images of a ceiling perpendicular to a direction of driving the robot cleaner, an obstacle detection sensor disposed on a front of the main body for detecting an obstacle positioned ahead of the robot cleaner in the driving direction, a memory for storing position information of the obstacles detected by the obstacle detection sensor; and a control unit for calculating position information of the obstacle to store the calculated obstacle position information in the memory upon receiving an obstacle detection signal from the obstacle detection sensor, determining whether the obstacle position information stored at the memory forms a closed curve, and further controlling the driving unit to drive the robot cleaner along a predetermined driving pattern, wherein the control unit stops the suction unit from operating when the obstacle position information forms a closed curve.

### BACKGROUND OF THE INVENTION

1. Field of the Invention

The present invention relates generally to a robot cleaner, a robot cleaning system and a method for controlling the same, and more particularly to a robot cleaner, a robot cleaning system and a method for controlling the same capable of independently determining whether the required cleaning work in a work area is completed and completing the cleaning work in the work area, and thereafter moving to another area for cleaning work or standing by for another command.

2. Background of the Related Art

With a general conventional robot cleaner, a user determines the general outline of a work area to be cleaned and an efficient driving path in the work area to input to a control unit, before starting the robot cleaner to clean the work area. Therefore, when the robot cleaner completes driving along the inputted driving path, the cleaning of the work area is also completed. However, this approach has a problem in that a user has to input a changed outline of the work area to the robot cleaner whenever any obstacle is introduced into the area or existing obstacles undergo changes in position.

To solve the above problem, a method is configured by which the robot cleaner drives along the outline of the work area that is surrounded by a wall or obstacle by using an ultrasonic sensor installed in a main body to determine the extent of the work area, and then plans a driving path for cleaning work to be done in the determined work area. Thereafter, the robot cleaner drives along the planned driving path, and then completes the cleaning of the work area by completing the driving. However, this method is subject to problems, such as requiring a long time for cleaning and thus consequently requiring a large battery capacity of, for the robot cleaner has to drive along the outline of the work area to determine the extent of the work area without actually performing the cleaning work.

Moreover, the user cannot recognize where the robot cleaner finished the cleaning work and cannot expect when the robot cleaner will complete the whole cleaning work until the work is completed.

Accordingly, a necessity has risen for a robot cleaner capable of independently determining whether cleaning work in a work area is completed and further notifying the user of progress of the cleaning work during the work.

### SUMMARY OF THE INVENTION

An object of the invention is to solve at least the above problems and/or disadvantages and to provide a robot cleaner, robot cleaning system and method for controlling the same capable of independently determining whether cleaning work is completed without previously inputting information of the work area by a user.

Another object of the invention is to provide a robot cleaner system capable of notifying the user of cleaning work progress during the cleaning work performed by the robot cleaner.

The foregoing objects and advantages are realized by providing a robot cleaner for performing cleaning work by communicating wirelessly with an apparatus external to the robot cleaner, comprising a main body provided with a suction unit for collecting dust on a floor to be cleaned; a driving unit disposed on the main body for driving a plurality of wheels; an upward-looking camera disposed on top of the main body for photographing images of a ceiling perpendicular to a direction of driving the robot cleaner; an obstacle detection sensor disposed on the front of the main body for detecting any obstacles positioned ahead of the robot cleaner in the driving direction; a memory for storing position information of the obstacles detected by the obstacle detection sensor; and a control unit for calculating position information of the obstacles so as to store the calculated obstacle position information in the memory upon receiving an obstacle detection signal from the obstacle detection sensor, determining whether the obstacle position information stored in the memory forms a closed curve, and further controlling the driving unit to drive the robot cleaner along a predetermined driving pattern, wherein the control unit stops the suction unit from operating when the obstacle position information forms a closed curve.

Here, the obstacle position information is stored in the form of a pixel unit of the images photographed by the upward camera.

The foregoing objects and advantages of the invention are further realized by providing a robot cleaning system comprising: a robot cleaner including: a main body provided with a suction unit for collecting dust on a floor to be cleaned, a driving unit disposed on the main body for driving a plurality of wheels, an upward-looking camera disposed on a top of the main body for photographing images of a ceiling perpendicular to a direction of driving the robot cleaner, and an obstacle detection sensor disposed on the front of the main body for detecting any obstacles positioned ahead of the robot cleaner in the driving direction; and a remote control unit for communicating wirelessly with the robot cleaner, wherein the remote control unit stores position information of the obstacle detected by the obstacle detection sensor and stops the suction unit of the robot cleaner from operating when the stored obstacle position information forms a closed curve.

Preferably, the remote control unit includes a memory for storing the obstacle position information and a display for displaying the images photographed by the upward camera.

Here, the display displays the obstacle position information by a pixel unit having a first indication symbol and displays that area cleaned by the robot cleaner by a pixel unit having a second indication symbol to distinguish it from the pixel units indicating the obstacle position information.

A method for controlling a robot cleaner having an obstacle detection sensor comprises the steps of determining whether the obstacle detection sensor operates during a cleaning work; storing position information of an obstacle when the obstacle detection sensor operates; determining whether the stored obstacle position information forms a closed curve; and stopping the cleaning work when the stored obstacle position information forms the closed curve.

As described above, with the robot cleaner, robot cleaning system and method for controlling the same, the control unit determines the work area by using the obstacle detection sensor so that the robot cleaner and the robot cleaning system can independently determine whether the cleaning work is completed.

With the robot cleaning system according to the invention, the display of the remote control unit displays the cleaned area by the robot cleaner so that the user can easily recognize the progress of the cleaning work.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a perspective view showing a robot cleaner according to the invention with an upper cover separated therefrom;

FIG. 2 is a schematic block diagram showing a robot cleaning system according to the invention;

FIG. 3 is a top plan view of a work area for illustrating the robot cleaner sensing an obstacle by an obstacle detection sensor and driving along a driving pattern;

FIG. 4 is a block diagram showing a detail of the central control unit of FIG. 2;

FIG. 5 is a view showing a screen shot on the display device shown in FIG. 4 when the robot cleaner, according to the invention completes the cleaning work in a predetermined work area; and

FIG. 6 is a flow chart diagram illustrating the method for controlling the robot cleaner according to the invention.

### DETAILED DESCRIPTION OF PREFERRED EMBODIMENTS

The preferred embodiments of the robot cleaner, of the robot cleaning system and of the method for controlling the same according to the present invention will be hereinafter described in detail with reference to the accompanying drawings.

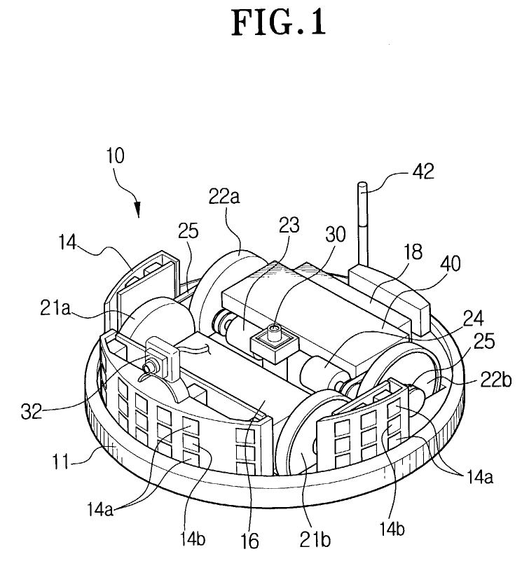

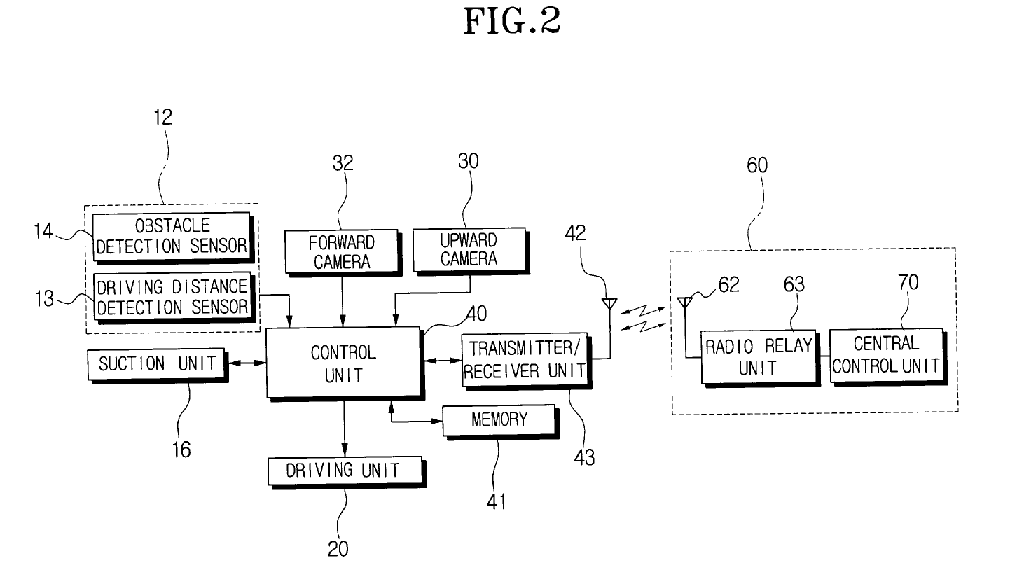

Referring to FIGS. 1 and 2, the robot cleaner 10 comprises a main body 11, a sensing unit 12, a suction unit 16, a charging battery 18, a driving unit 20, an upward-looking camera 30, a forward-looking camera 32, a control unit 40, a memory 41 and a transmitter/receiver unit 43 using an antenna 42.

The sensing unit 12 comprises one or more obstacle detection sensors 14 disposed around a cylindrical side wall of the main body 11 at predetermined intervals for sending an external signal and receiving a reflected signal from the environment outside the body 11, and a driving distance detection sensor 13 for measuring distances driven by the robot cleaner 10.

The obstacle detection sensor 14 includes a plurality of infrared ray luminous elements 14a for projecting infrared rays and light-receiving elements 14b for receiving infrared rays, wherein the elements are disposed along an outer circumference of the obstacle detection sensor 14 by perpendicularly arranged pairs. In another case, the obstacle detection sensor 14 may adopt an ultrasonic sensor capable of projecting an ultrasound signal and receiving a reflected ultrasound signal. The obstacle detection sensor 14 is also used for measuring the distance between the robot cleaner 10 and an obstacle or an adjacent wall.

The driving distance detection sensor 13 (FIG. 2) may adopt a rotation detection sensor for detecting the frequency of rotation of wheels 21a, 21b, 22a and 22b driven by motors 23, 24. For example, the rotation detection sensor may adopt an encoder for detecting the frequency of rotation of the motors 23, 24.

The suction unit 16 is installed on the main body 11 in order to collect dust on an opposing floor to be cleaned while drawing in air. The suction unit 16 may be constructed using well-known methods. The suction unit 16, for example, may have a suction motor (not shown) and a suction chamber, for collecting the air drawn in through a suction hole or a suction pipe formed opposite to the floor to be cleaned by driving of the suction motor.

The charging battery 18 is installed on the main body 11 for supplying power to the motors of the driving unit 20, to the control unit 40, to the sensing unit 12, etc.

The driving unit 20 comprises two wheels 21a, 21b disposed at both sides of the front of the main body 11, and two wheels 22a, 22b disposed at both sides of the back of the main body 11, and motors 23, 24 for rotatably driving the back wheels 22a, 22b respectively and a timing belt 25 for transmitting power generated to the back wheels 22a, 22b by the motors 23, 24, to the front wheels 21a, 21b. The driving unit 20 rotatably drives the motors 23, 24 independently in a forward or reverse direction in accordance with control signals received from the control unit 40. The driving direction of the robot 10 may be determined by controlling the motors 23, 24 to have different frequencies of rotation.

The forward-looking camera 32 is installed on the main body 11 in order to photograph front images in a forward direction and to output the photographed images to the control unit 40.

The upward-looking camera 30 is disposed on the main body 11 so as to be capable of photographing images of a ceiling disposed in an upward direction and to output the photographed images to the control unit 40.

The transmitter/receiver unit 43 sends data through an antenna 42, and transmits a signal received through the antenna 42 to the control unit 40.

The control unit 40 processes received signals through the transmitter/receiver unit 43. In the case for which the main body 11 further comprises a key input device (not shown) having a plurality of keys so that a user can manipulate the keys to set operational functions, the control unit 40 may process an input key signal from the key input device.

The control unit 40 drives the robot cleaner 10 in order for the suction unit 16 to perform cleaning work, and stores information regarding the cleaned area in the memory 41. The control unit 40 also determines whether any obstacle to the driving path of the robot cleaner 10 exists by means of a detection signal inputted from the obstacle detection sensor 14 while driving the robot cleaner 10, and calculates a distance from the robot cleaner to the obstacle where the obstacle is detected. Thereafter, the control unit 40 stores the position information of the obstacle in the memory 41. The control unit 40 then controls the driving unit 20 to change the driving direction of the robot cleaner 10 in accordance with a predetermined driving pattern and then continues driving the robot cleaner 10 to perform the cleaning work. When another obstacle is detected while driving the robot cleaner 10, the control unit 40 calculates position information of the obstacle and again stores the calculated information in the memory 41.

Next, the control unit 40 determines whether the stored obstacle position information forms a closed curve. When the stored obstacle position information is calculated as having formed a closed curve, the control unit 40 determines whether all of the area inside the closed curve is completed cleaned. When the cleaning operation is completed, the control unit 40 stops the suction unit 16 from operating and finishes the cleaning work.

Various known methods may be adopted to determine whether the stored obstacle position information forms a closed curve. For example, in the case in which the image is divided into a plurality of pixels and the obstacle position information is stored as the position information of specific pixels, a method may be adopted that determines whether pixels corresponding to the obstacle position information are continuously connected to each other.

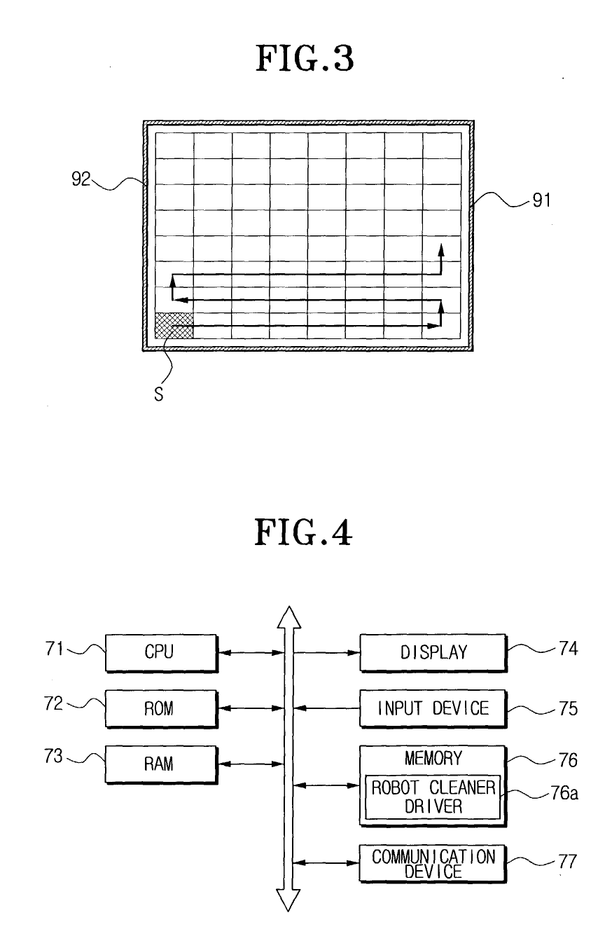

A driving pattern of the robot cleaner may be arbitrarily chosen by a user so as to be most effective for the specific cleaning work desired, which may be, for example, a side-to-side pattern, as shown in FIG. 3.

The operation of the control unit 40, which determines whether the cleaning work is completed by using the obstacle detection sensor, will be described hereinafter by referring to an example of a work area which has a rectangular form surrounded by walls as shown in FIG. 3. Here, the drive pattern of the robot cleaner is the side-to-side pattern.

The robot cleaner 10 operates the suction unit 16 and then moves in the forward direction from the stand-by state S, upon receiving a work command signal from a key input device or from outside wirelessly. Alternatively, the cleaning work may be controlled by a timing sequence to automatically perform cleaning operations if the surface to be cleaned has not been cleaned for a predetermined period. Upon detecting the right wall 91 during driving of the robot cleaner 10, the obstacle detection sensor 14 transmits an obstacle detection signal to the control unit 40. Upon receiving the obstacle detection signal, the control unit 40 calculates a distance form the robot cleaner 10 to the obstacle and stores the position of the obstacle in the memory 41. Thereafter, the robot cleaner 10 turns 90 degrees and moves a predetermined distance, essentially corresponding to the width of a suction hole or a suction pipe of the suction unit 16. The robot cleaner 10 turns again by 90 degrees in the same direction as the previous turn, to return to the reverse of previous driving direction and determines whether any obstacle exists ahead of the robot cleaner 10. When there is no obstacle ahead, the robot cleaner 10 drives straight ahead or in accordance with the predetermined instructions received from the control unit 40. However, the robot cleaner 10 turns 180 degrees and drives in the reverse direction to continue the cleaning work, when there is an obstacle, such as a wall 91, as is shown at the right in the embodiment in FIG. 3. Upon detecting the left side wall 92, while the robot cleaner 10 drives in the reverse direction, the obstacle detection sensor 14 again transmits a signal to the control unit 40. The control unit 40, then, calculates the distance from the robot cleaner 10 to the obstacle, as here the left wall 92, and stores the position information of the obstacle in the memory 41. Thereafter, the robot cleaner 10 turns 90 degrees in the right or clockwise direction, and moves the distance corresponding to the width of a suction hole or a suction pipe of the suction unit 16, and again turns in the same direction as the previous turn by 90 degrees to return to the reverse of the previous driving direction and determines whether any obstacle exists ahead of the robot cleaner 10. The robot cleaner 10 drives straight ahead when there is no obstacle ahead, but the robot cleaner 10 turns 180 degrees and drives to the reverse direction when there is the obstacle, such as wall 92. Here, the control unit 40 as controls the driving unit 20 to repeat the above operation, thus, whenever detecting an obstacle, the control unit 40 stores the position information of the obstacle and determines whether the stored obstacle position information forms a closed curve.

When the obstacle position information is determined to not form the closed curve, the control unit 40 controls the driving unit 20 to continue performing the cleaning work. However, when the obstacle position information forms the closed curve, the control unit determines whether the cleaning work for all area inside the closed curve is completed. When there is any area that has not been cleaned inside the closed curve, the robot cleaner 10 moves to that area to perform the cleaning work. Thereafter, the control unit 40 stops the suction unit 16 from operating so as to finish the cleaning work when the cleaning work is completed for all area inside the closed curve. The robot cleaner 10, consequently, moves to another room for a cleaning work or returns to the stand-by state S according to the appropriate command.

The operation of the robot cleaner has been described by way of an example of the method by which control unit 40 directly processes to recognize the work area and to determine when the cleaning work has been completed.

According to another aspect of the invention, a robot cleaning system is provided which may process data with respect to a work area externally so as to notify a user of the work area and of the progress of the cleaning work, in order to reduce the operational load required to recognize the completion of the cleaning work for the work area by the robot cleaner 10.

To this end, the robot cleaner 10 is configured to wirelessly send the photographed image information and obstacle detection signal information externally, and further to operate in response to a control signal received from an external source of commands. A remote controller 60 is configured to wirelessly control the driving of the robot cleaner 10. The remote controller 60 comprises a radio relay unit 63 and a central control unit 70, as shown in FIG. 2.

The radio relay unit 63 processes a radio signal from the robot cleaner 10 to transmit the processed signal to the central control unit 70 by a wire connection, and wirelessly sends a signal received from the central control unit 70 to the robot cleaner 10 through an antenna 62.

The central control unit 70 may be a conventional computer configuration, of which one example is shown in FIG. 4. Referring to FIG. 4, the central control unit 70 comprises a CPU 71, a ROM 72, a RAM 73, a display 74, an input device 75, a memory 76 and a communication device 77.

The memory 76 is provided with a robot cleaner driver 76a for controlling the robot cleaner 10 and for processing signals from the robot cleaner 10.

Upon being operated, the robot cleaner driver 76a provides the user with a menu at the display 74 for setting up the control of the robot cleaner 10, and processes a menu item selected by the user to be performed by the robot cleaner 10. Preferably, the menu may include a command for commencing cleaning work and an observation work command as primary classifications. The menu may further provide sub-selection menus such as a target area selection list and methods for cleaning for each primary classification.

The robot cleaner driver 76a uses the received upper image and marks displayed on the ceiling as stored information for recognition of the current position of the robot cleaner 10, and stores the driving path, by which the robot cleaner 10 will be directed with the suction unit 16 being operated, as the cleaned area in the memory 76.

When the obstacle detection sensor 14 detects an obstacle while the robot cleaner 10 drives to the area to be cleaned, the control unit 40 transmits an obstacle detection signal to the remote control unit 60 through the transmitter/receiver unit 43. Upon receiving the obstacle detection signal, the robot cleaner driver 76a (FIG. 4) calculates the distance from the robot cleaner 10 to the obstacle and stores the position information of the obstacle in the memory 76. Consequently, the robot cleaner driver 76a determines whether the stored obstacle position information forms a closed curve, and controls the driving unit 20 so as to change the driving path of the robot 10 to continue the cleaning work when the stored obstacle position information does not form a closed curve.

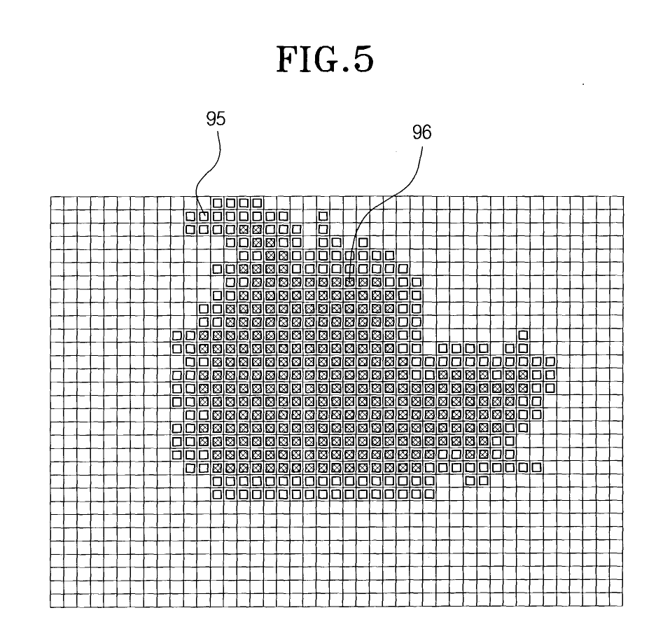

It is preferable that the robot cleaner 10 displays the position of the obstacle and position where the cleaning is completed on the display 74 in order to show to the user the obstacle positions and the positions or area where the cleaning has been completed. FIG. 5 shows an example of the above information displayed on the display 74.

Referring now to FIG. 5, the upper image photographed by the upward camera is displayed as a background on the display 74, on which the upper image is divided into a plurality of pixels, as shown. When an obstacle is detected, the robot cleaner driver 76a calculates the position of the obstacle and displays the position of the obstacle by changing the colors of the pixels on the display 74 corresponding to the calculated obstacle position into a specified color. Further, the robot cleaner driver 76a calculates positions of the area passed by the robot cleaner 10 while performing the cleaning operation, and displays the position of the cleaned area by changing the colors of the pixels on the display 74 corresponding to the calculated clean area position into a specified color. Here, the positions of the obstacle 95 and the cleaned area 96 are displayed in different specified colors. For example, the position of the obstacle 95 may be displayed as red, while the position of the cleaned area 96 may be displayed as blue.

The robot cleaner driver 76a determines whether the pixels 95 representing the obstacle form a closed curve whenever the robot cleaner driver 76a displays the position of the obstacle 95 on the display 74 by a pixel unit. When the pixels 95 for the obstacle form a closed curve, the robot cleaner driver 76a also confirms whether the cleaning of all the area inside the closed curve is completed. Thus, if there is any area inside the closed curve, which has not yet been cleaned, the robot cleaner driver 76a moves the robot cleaner 10 to that area to complete the cleaning work. Thereafter, the robot cleaner driver 76a controls the robot cleaner 10 to move to another area or to stand by at a predetermined position in response to the next received next command from the CCU 70. FIG. 5 shows that the pixels 95 representing the obstacle form a closed curve and all of the pixels 96 inside the closed curve represent the clean areas, thus one can see that the cleaning of the work area is completed.

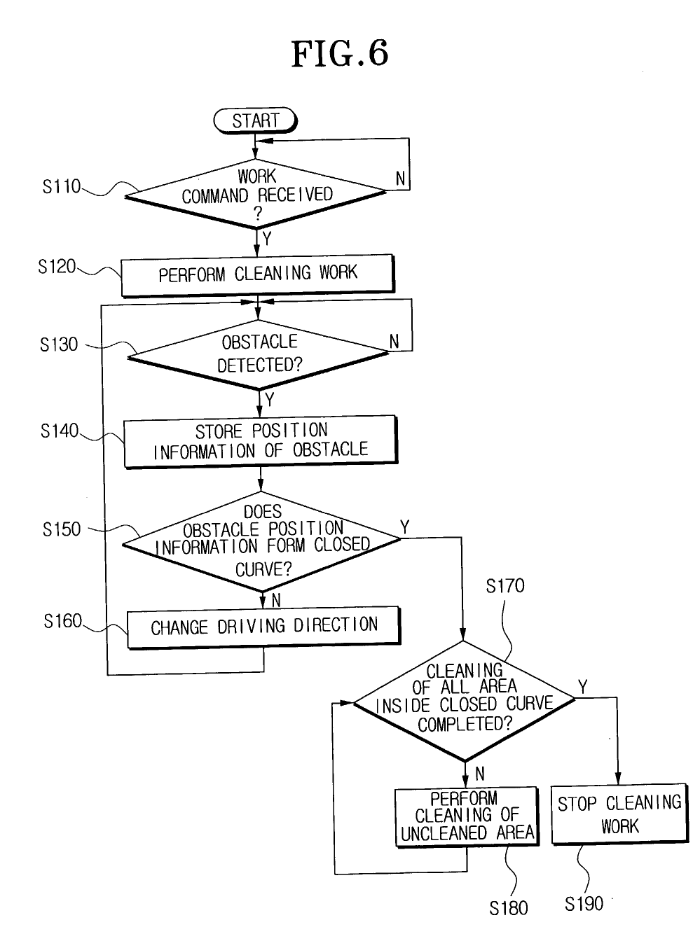

The control unit 40 of the robot cleaner 10 controls the driving unit 20 in response to control information received from the robot cleaner driver 76a through the radio relay unit 63, and, thus, can reduce the operational load for determining whether the cleaning work of the work area is completed, by using the obstacle position information. The control unit 40 further transmits obstacle information detected by the obstacle detection sensor 14 to the central control unit 70 through the radio relay unit 63 while the robot cleaner 10 drives. Hereinafter, a method for controlling the robot cleaner 10 by the control unit 40, which uses the obstacle detection sensor to determine whether cleaning work for a work area is completed, will be described in detail with reference to FIG. 6.

First, the control unit 40 decides whether a work command has been received, S110.

When the work command is received, the control unit 40 starts to perform the cleaning work by operating the suction unit 16 and controls the driving unit 20 to move straight in the forward direction, S120.

The control unit 40 then determines whether an obstacle detection signal is received from the obstacle detection sensor while the robot cleaner drives as performing the cleaning work, S130.

Upon receiving the obstacle detection signal, the control unit 40 calculates a distance from the robot cleaner 10 to the obstacle and stores the position information of the obstacle in the memory, S140.

Thereafter, the control unit 40 determines whether the position information of the obstacle stored in the memory forms a closed curve, S150.

When the stored obstacle position information does not indicate that a closed curve is formed, the control unit 40 controls the driving unit 20 to change the driving direction of the robot cleaner 10, S160. Here, the degree of the change of the driving direction depends on the driving pattern that may be arbitrarily chosen by the user. For example, when the driving pattern is a zigzag or back and forth pattern, the robot cleaner 10 turns 90 degree and drives straight for a predetermined distance, whereby the robot cleaner 10 turns 90 degree in a reverse direction, to the original driving direction, to drive oppositely to the previous driving direction. When an obstacle is detected in the direction of driving, the robot cleaner 10 turns 180 degrees to drive in the reverse direction, opposite to the previous driving direction. Preferably, the predetermined distance between back and forth segments driven by the robot cleaner 10 here may be narrower than the length of the suction region of the suction unit.

The control unit 40 drives the robot cleaner 10 to change the driving direction and perform the cleaning work, and loops back to step S130 for determining whether a obstacle detection signal is received from the obstacle detection sensor. When an obstacle is detected ahead of the robot cleaner in the direction of driving, the position information of the obstacle is stored in the memory, S140.

When the obstacle position information stored at step S140 forms a closed curve, the control unit after making that determination in the decision step S150 determines whether the cleaning work for all area inside the closed curve is completed, S170. When there is any unclean area inside the closed curve, the control unit 40 controls the driving unit to move the robot cleaner to the unclean area so as to perform cleaning work, S180.

Next, the control unit 40 stops the suction unit from operating when the control unit 40 determines that the cleaning work inside the closed curve is completed, S190.

The control unit 40, then, controls the driving unit to move the robot cleaner to a predetermined position and to stand by for another command, when the control unit does not receive any further immediate command.

As described above, the robot cleaner according to the invention can perform cleaning work by independently determining the work area without requiring previously inputted information of the work area and further can stop the cleaning work when the work is completed. Furthermore, with the robot cleaning system according to the invention, the user can recognize progress of the cleaning work, for the robot cleaner can display distinctively the cleaned areas and unclean areas on the display. Therefore, when the robot cleaner repeats the cleaning work for the same area, a time of completing the cleaning work may be approximated. Furthermore, the robot cleaner does not need to drive along the outline of the work area before starting the cleaning work, thereby reducing the period of time spent for the cleaning work and further reducing the consumption of the charged battery.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A robot cleaner for performing cleaning work by communicating wirelessly with an apparatus external to the robot cleaner, comprising:
a main body provided with a suction unit for collecting dust on floor or surface to be cleaned;
a driving unit disposed at the main body for driving a plurality of wheels;
an upward-looking camera disposed on a top of the main body for photographing images of a ceiling perpendicular to the direction of driving the robot cleaner;
an obstacle detection sensor disposed at a front of the main body for detecting an obstacle positioned ahead of the robot cleaner in the direction of driving the robot cleaner;
a memory for storing position information of obstacles detected by the obstacle detection sensor; and
a control unit for calculating position information of the obstacles to store the calculated obstacle position information in the memory upon receiving an obstacle detection signal from the obstacle detection sensor, determining whether the obstacle position information stored in the memory forms a closed curve, and further controlling the driving unit to drive the robot cleaner along a predetermined driving pattern, wherein the control unit stops the suction unit from operating when the obstacle position information forms a closed curve.

2. The robot cleaner according to claim 1, wherein the obstacle position information is stored by pixel unit of the images photographed by the upward-looking camera.

3. A robot cleaning system comprising:
a robot cleaner including
a main body provided with a suction unit for collecting dust on a floor to be cleaned,
a driving unit disposed on the main body for driving a plurality of wheels,
an upward-looking camera disposed on a top of the main body for photographing images of a ceiling perpendicular to the driving direction of the robot cleaner, and
an obstacle detection sensor disposed on the front of the main body for detecting obstacles positioned ahead of the robot cleaner in the direction of driving; and
a remote control unit for communicating wirelessly with the robot cleaner,
wherein the remote control unit stores position information of the obstacles detected by the obstacle detection sensor and stops the suction unit of the robot cleaner from operating when the stored obstacle position information forms a closed curve.

4. The robot cleaning system according to claim 3, wherein the remote control unit includes a memory for storing the obstacle position information and a display for displaying the images photographed by the upward-looking camera.

5. The robot cleaning system according to claim 4, wherein the display displays the obstacle position information by pixel units.

6. The robot cleaning system according to claim 5, wherein the display displays the area already cleaned by the robot cleaner by pixel units having a distinguishing feature from the pixel units displaying the obstacle position information.

7. A method for controlling a robot cleaner having an obstacle detection sensor, comprising the steps of:
determining whether the obstacle detection sensor operates during a cleaning operation;
storing position information of any obstacles when the obstacle detection sensor so operates;
determining whether the stored obstacle position information forms a closed curve; and
stopping the cleaning work when the stored obstacle position information forms a closed curve.

8. The method according to claim 7, further comprising the step of determining whether the cleaning work of all area inside the closed curve has been completed when the stored obstacle position information forms a closed curve.
